(19) United States
(12) Patent Application Publication
(10) Pub. No.: US 2024/0290951 A1
(43) Pub. Date: Aug. 29, 2024

(54) CORE/SHELL ANODE ARRANGEMENT HAVING CONTINUOUS, ION-CONDUCTING NETWORK

(71) Applicant: Lyten, Inc., San Jose, CA (US)

(72) Inventors: Yunguang Zhu, Santa Clara, CA (US); Yongtao Meng, Fremont, CA (US)

(73) Assignee: Lyten, Inc., San Jose, CA (US)

(21) Appl. No.: 18/241,688

(22) Filed: Sep. 1, 2023

Related U.S. Application Data
(60) Provisional application No. 63/448,640, filed on Feb. 27, 2023.

(51) Int. Cl. H01M 4/36; H01M 4/583; H01M 50/103; H01M 50/105; H01M 50/109

(52) U.S. Cl. CPC H01M 4/366; H01M 4/583; H01M 50/103; H01M 50/105; H01M 50/109; H01M 2004/021; H01M 2004/027

(57) ABSTRACT

Current collectors are critical components of conventional electrochemical cell design, and serve to conduct electricity generated within the electrochemical cell to an external environment of the electrochemical cell, typically to a machine or device electrically coupled to the electrochemical cell, e.g. via a plurality of leads, tabs, contacts, terminals, etc. Accordingly, current collectors conventionally comprise one or more highly electrically conductive (and, optionally, thermally conductive) materials, most often metal(s) or alloy(s) of iron, nickel, copper, etc. As a result, current collectors often represent a substantial contribution to the total mass of the electrochemical cell, and undesirably reduce the power-to-weight ratio of the resulting battery. The presently disclosed inventive concepts include various configurations of free-standing electrodes that do not require a distinct current collector component to efficiently conduct electricity to external devices, and include unique compositions and structural arrangements that collectively convey substantial performance improvements on electrochemical cells implementing the same.

### PRIORITY CLAIM

The present application claims priority to U.S. Provisional Patent Application No. 63/448,640, filed Feb. 27, 2023 and entitled “Three-Dimensional (3D) Anode For High-Power Lithium-Based Batteries”, the contents of which are herein incorporated by reference.

### FIELD OF THE INVENTION

The present invention relates to battery technology, and more particularly to free-standing, three-dimensional (3D) anode configurations having a continuous, ion-conducting network for high power batteries and corresponding applications.

### BACKGROUND

Li metal and lithium-based materials (e.g., lithium alloys, lithium composites, etc.) are believed as the most promising anode material for modern battery applications because of low mass, high theoretical capacity (3860 mAh/g), low redox potential (−3.04 V vs SHE), and other characteristics. Sodium metal, as well as alloys and composites thereof are also attractive candidates for anode materials owing to similarly attractive performance characteristics, good mechanical strength, and ease of access.

However, lithium and sodium-based materials often suffer from instability with cycling due to large volumetric changes during cycling (˜0.49 cm³/Ah for lithium, and 0.89 cm³/Ah for sodium), parasitic side reactions with electrolytes, dendrite formation, etc. as is well documented in the art.

The foregoing effects can be severe enough to cause failure of the electrochemical cell, even to the point of rupture, causing concomitant safety issues. Even without causing failure, the volumetric changes and formation of dendrites causes capacity loss and reduces the power output of the battery, with increasingly negative impact over increasing number of charge cycles, reducing the operational lifetime of the battery.

Some have proposed the use of a three-dimensional (3D) anode structure for modern batteries, where an active anode material is formed (typically by deposition) onto a highly porous and electrically conductive substrate materials such as copper, nickel, carbon nanotubes, carbon fibers, or graphene, which may be formed by dealloying, etching, sol-gel synthesis, etc. These high surface area substrates are often referred to as “foams” of the respective materials.

Other approaches involve suspending ion-conducting materials (particles) within a binder matrix, typically a polymer, and optionally coating particles or monoliths of anode active material with such a polymeric, ionically conductive layer to improve performance and extend operational lifetime of modern battery configurations.

However, these structures are characterized by limited ion diffusion pathways, such that metal (e.g., lithium) is plated on top of the conductive substrate or binder matrix rather than penetrating into pores or otherwise being incorporated in the interior volume of the structure. The resulting 3D electrode inevitably transforms into a bi-layer structure having electrochemically reactive anode material on one side (typically the side facing the separator or equivalent structure/component) and an inert 3D network on the other side (typically the side facing the current collector or equivalent structure/component). Consequently, conventional 3D structures and corresponding approaches have failed to adequately address the problems associated with volumetric change, dendrite formation, parasitic reactions with electrolyte, etc. that are known to be associated with use of lithium-based materials in batteries, particularly in the anode.

The above challenges are major limiting factors to ubiquitous use of lithium-based and sodium-based batteries, including Li—S batteries as such, there is thus a need for addressing these and/or other issues associated with the prior art.

### BRIEF DESCRIPTION OF THE DRAWINGS

FIGS. 1A-1C are scanning electron micrograph (SEM) images of a three-dimensional (3D) composite anode, in accordance with one embodiment.

FIG. 2A is a photograph of a pristine 3D composite anode, in accordance with one embodiment.

FIG. 2B is a photograph of the 3D composite anode as shown in FIG. 2A, after stripping, in accordance with one embodiment.

FIG. 2C is a graph showing voltage profiles of a symmetric cell including a 3D composite anode versus a symmetric cell including a lithium foil anode, in accordance with one embodiment.

FIG. 2D is a graph showing X-ray diffraction (XRD) profiles of the 3D composite anode as shown in FIGS. 2A and 2B, before and after stripping, in accordance with one embodiment.

FIG. 3A is a microscopic image of a 3D composite electrode surface facing the current collector, in accordance with one embodiment.

FIG. 3B is a microscopic image of a 3D composite electrode surface facing the separator, in accordance with one embodiment.

FIG. 3C is a microscopic image of a lithium counter electrode surface facing the separator, in accordance with one embodiment.

FIG. 4 is a chart showing various forms of macroscale carbonaceous material, and methods of producing the same from elemental carbon (e.g., charcoal), which may be included in various components of electrochemical cells.

FIG. 5 is a chart showing various forms of nanoscale carbonaceous material, and methods of producing the same from elemental carbon (e.g., charcoal), which may be included in various components of electrochemical cells.

FIG. 6A is a simplified schematic of a planar electrode, in accordance with one embodiment.

FIG. 6B is a simplified schematic of a 3D composite electrode, in accordance with one embodiment.

FIG. 6C is a simplified schematic of core-shell arrangement of a 3D composite electrode, according to one embodiment.

FIG. 6D is a simplified schematic of core-shell arrangement of a 3D composite electrode, according to one embodiment.

FIG. 7 is a simplified schematic flow gram showing steps of a process for fabricating a 3D composite electrode, in accordance with one embodiment.

FIG. 8A shows a simplified schematic cross-sectional view of an electrochemical cell characterized by a pouch cell arrangement, according to one embodiment of the presently disclosed inventive concepts.

FIG. 8B is a simplified schematic external view of the electrochemical cell shown in FIG. 8A, according to one embodiment of the presently disclosed inventive concepts.

FIG. 8C depicts a simplified schematic of the pouch cell arrangement shown in FIG. 8B, wrapped into a jelly-roll configuration, according to one approach of the presently disclosed inventive concepts.

FIG. 9A is a simplified schematic of an electrochemical cell characterized by a coin cell arrangement, according to one implementation of the presently disclosed inventive concepts.

FIG. 9B depicts various components of the coin cell arrangement shown in FIG. 9A, according to a simplified schematic exploded view.

FIG. 10A is a simplified schematic of an electrochemical cell characterized by a cylindrical cell arrangement, according to one aspect of the presently disclosed inventive concepts.

FIG. 10B is a simplified schematic cut-out view of exemplary components of the cylindrical cell arrangement shown in FIG. 10A, according to one implementation of the presently disclosed inventive concepts.

FIG. 11 is a simplified schematic of an electrochemical cell characterized by a cylindrical cell arrangement, according to one aspect of the presently disclosed inventive concepts.

### DETAILED DESCRIPTION

As noted above, conventional lithium-based batteries suffer from volumetric changes associated with stripping and plating, and formation of dendrites, each of which convey disadvantageous characteristics including capacity loss, low power output, and susceptibility to internal shorting, cell failure, and may cause safety hazards such as fire.

To solve problems associated with volumetric changes and dendrite formation of lithium-based and sodium-based batteries, particularly batteries employing a lithium-based or a sodium-based anode, the presently disclosed inventive concepts utilize a 3D frame, which can host lithium-based and/or sodium-based materials, such as lithium metal, lithium alloys, lithium composite materials, sodium metal, sodium alloys, sodium composite materials, and combinations thereof.

According to various implementations, such anodes may include one or more anode active materials and a continuous, ion-conducting network, as described in greater detail below.

According to preferred implementations, the anode active material is present in the form of a three-dimensional, monolithic structure that is “free-standing”. In other words, the anode active material is “structurally self-supporting”, such that no separate substrate, framework, scaffold, foam, matrix, current collector, supporting fluid, etc. is necessary for the monolith to support its own weight and maintain defining physical characteristics (e.g., density, volume, overall dimensions, etc.) when deposited or otherwise placed in a working environment such as an electrochemical cell.

Indeed, as will become apparent from reading the descriptions provided herein in view of the various drawings, the presently described inventive concepts are unique, according to one aspect, in that the anode active material itself serves as a substrate, scaffold, framework, etc. into and/or onto which other useful materials (such as ionically conductive materials) may be formed, deposited, etc. to generate a 3D monolithic structure with superior ionic conductivity, better ion diffusion pathways, and corresponding performance improvements relative to the conventional structures described hereinabove employing different structural arrangements, including but not limited to metal or carbon-based foams, polymer coatings or matrices with anode active material and/or ion conducting material(s) therein, etc. According to select implementations, the 3D monolith is substantially non-porous (e.g., less than about 1% of an inner volume of the 3D monolith is attributable to void volume), or completely non-porous.

According to various aspects, the anode active material(s) forming the free-standing, monolithic 3D structure may be or include elemental Li, Li—Mg, Li—Si, Li—C, Li—Li₃N, Li—Li₂O, Li—LiFePO₄, Li-NMC, Li-NCA, Li—LiCoO₂, elemental Na, Na—Sn, Na—Si, Na—C or any suitable equivalent(s) or combination(s) thereof that would be appreciated by a person having ordinary skill in the art upon reading the instant descriptions.

In addition to the foregoing free-standing, monolithic 3D structure of exemplary anode active materials described herein, the presently disclosed inventive concepts include the notion of forming a continuous, ion-conducting network on or in surfaces and/or a bulk of the 3D structure. Importantly, forming a continuous network in accordance with said inventive concepts involves forming a homogenous distribution, or a substantially homogenous distribution, of ion-conducting material(s) on or in the anode active material that forms the 3D structure.

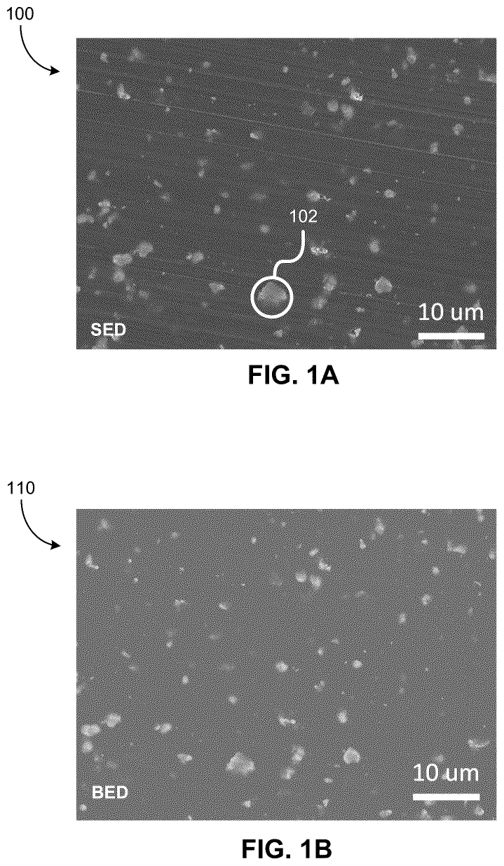

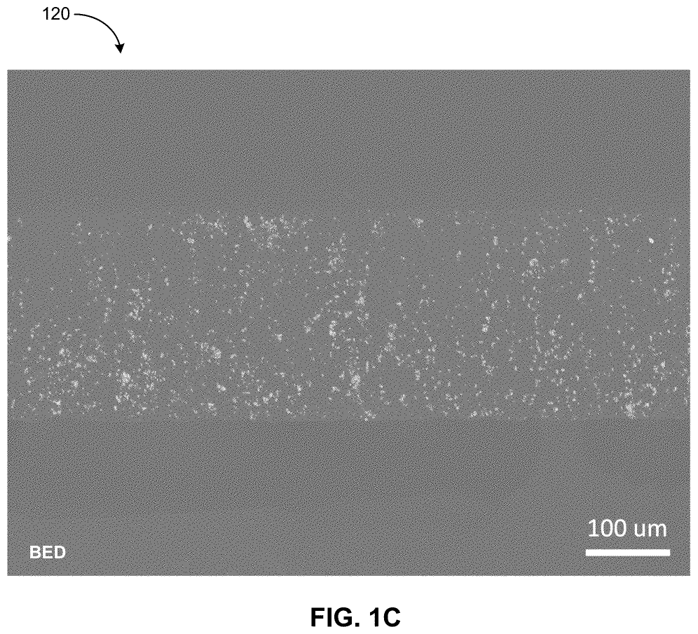

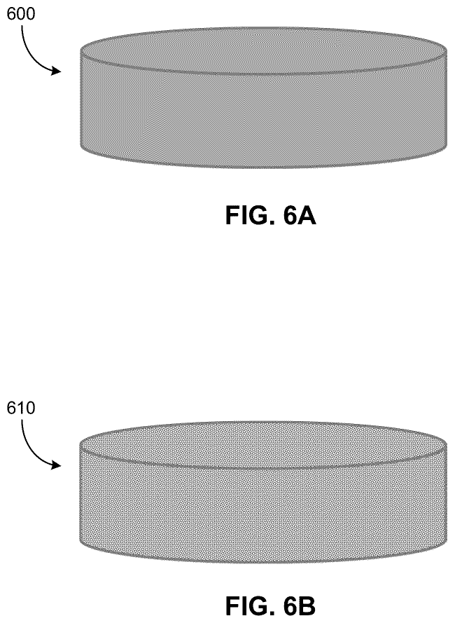

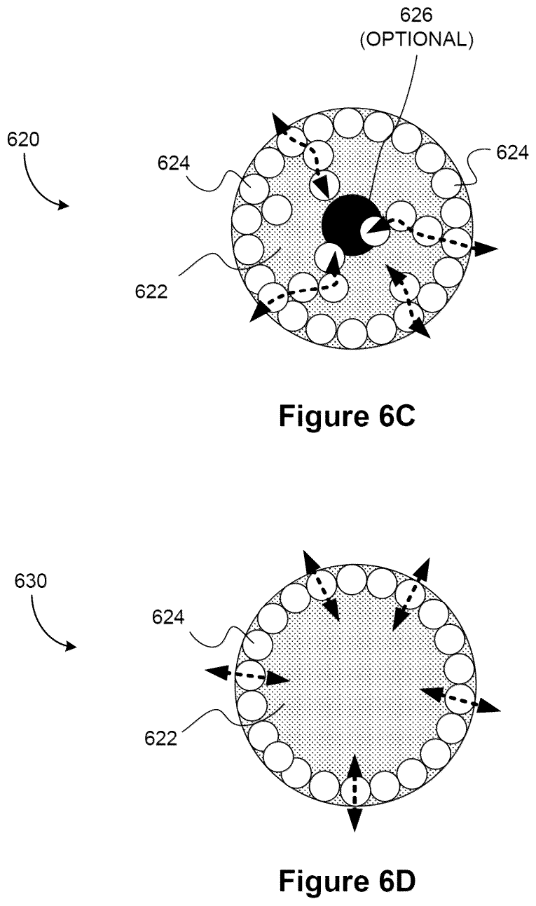

As described in greater detail below with general reference to FIGS. 1A-1C, 6C-6D and according to several suitable embodiments, forming a continuous, ion-conducting network involves distributing select ion-conducting materials (e.g., lithium ion-conducting materials and/or sodium ion-conducting materials such as Li₇La₃Zr₂O₁₂ (LLZO), LiAlO₂, Beta-Al₂O₃(Li+), Li₆P₂S₅Cl, Li₆P₂S₅Br, Li₆P₂S₅I, Li₄Ti₅O₁₂, LiFePO₄, LiCoO₂, LiNiO₂, LiNi_{0.5}Mn_{0.1}Co_{0.1}O₂ (NMC811), LiNi_{0.33}Mn_{0.33}Co_{0.33}O₂ (NMC111), LiNi_{0.6}Mn_{0.2}Co_{0.2}O₂ (NMC622), Li₄Ti₅O₁₂ (LTO), LiVO₂ (LVO), SiO₂, SnO₂, NiO, one or more sodium super ionic conductors (NASICONs), NaN(SO₂F)₂, Na₃PS₄, Na₃SbS₄ ceramic, Na₂S—SiS₂ glass, and combinations thereof. As understood herein, “NASICON compositions” refer to a family of solids with the chemical formula Na₁₊ₓZr₂SiₓP₃₋ₓO₁₂, where 0<x<3. Further, NASICON compositions also include similar compounds where Na, Zr and/or Si are replaced by isovalent elements.

Preferably, the materials of the 3D frame, and/or additional lithium ion-conducting materials that may be deposited on surfaces and/or disposed in the bulk of the 3D frame provide fast Li⁺ and/or Na⁺ ion conductivity. With an ion-conductive frame, the inventive anode structures presented herein can advantageously maintain a stable volume, even after stripping. Moreover, dendrite formation can be mitigated, or even prevented, due to the high surface area of the 3D frame. This phenomenon may be understood in context of the Sand's time equation (see Equation 1 below, H. J. S. Sand, Philos. Mag., 1901, 1, 45-79).

$${t}_{Sand} = π {D}_{app} \frac{{( {z}_{c} {c}_{0} F )}^{2}}{4 {( {Jt}_{a} )}^{2}} \qquad ( Eq . 1 )$$

where z_{c} is the charge number of the cation (z_{c}=1 for Li⁺ and Na⁺), c₀ is the bulk salt concentration, F is the Faraday's constant, J is the current density, and t_{Li} and tₐ=1−t_{Li} are the transference numbers of lithium cations and associated anions.

According to Equation 1, as specific current density (J) decreases, dendrite formation time is extended. Therefore, a 3D anode having a high surface area can minimize Li dendrite formation by increasing the “Sand's time”.

In addition to good stability of the resulting 3D anode, the unique high surface area combined with improved ion diffusion pathways of the 3D structure advantageously conveys a high-rate capability of corresponding batteries, as described in further detail hereinbelow.

Compared to traditional, electrically conductive 3D hosts, the inventive continuous, ion-conducting network facilitates homogenous distribution of ions (particularly ions of sodium and/or lithium) throughout electrolyte material(s) and/or the 3D monolithic anode structure. In some approaches, including an insulating material could also minimize parasitic side reactions with electrolytes. Therefore, the inventive 3D composite electrodes described herein provide superior cycling performance (including, but not limited to, longer cycle life, higher C-rate and Coulombic efficiency) than conventional compositions. In addition, due to high surface area, the inventive concepts described herein improve the rate capability substantially compared with the traditional 3D anode configuration.

### General Embodiments

According to one general embodiment, an anode includes a three-dimensional (3D) monolith comprising at least one anode active material; and a continuous ion-conducting network formed on surface(s) and/or in a bulk of the 3D monolith, where the ion-conducting network comprises one or more ion-conducting materials.

According to another general embodiment, an anode includes a core comprising at least one anode active material; and a shell comprising a continuous ion-conducting network surrounding the core.

According to yet another general embodiment, an anode includes: a core; and a shell surrounding the core. The core comprises either: one or more lithium alloys, one or more lithium composite materials, one or more sodium alloys, one or more sodium composite materials, or combinations thereof; and the shell comprises a plurality of particles including one or more ion-conducting materials selected from the group consisting of: Li₄Ti₅O₁₂ (LTO), LiVO₂ (LVO), Li—LiFePO₄, Li—LiMgPO₄, or combinations thereof. The shell forms a continuous, ion-conducting network between the core and an environment external to the anode.

Additional aspects and embodiments of the inventive concepts presented herein are described in greater detail hereinbelow with reference to the drawings.

Accordingly, the presently disclosed inventive concepts address problems associated with use of lithium-based and sodium-based materials in batteries, even materials having a 3D monolithic structure including an electrically conductive material therein, at least in part by including a material that is ionically conductive to lithium or sodium in the 3D structure of the lithium-based or sodium-based electrode. Preferably, the lithium or sodium ion-conducting material is present in and/or on surfaces and/or a bulk of the 3D structure. More preferably, the ion-conducting material is substantially homogenously distributed throughout the volume of the 3D monolithic structure, as shown and described in greater detail with respect to FIGS. 1A-1C hereinbelow.

According to various implementations, the anode active material(s) may include lithium metal, one or more lithium alloys, one or more lithium composite materials, sodium metal, one or more sodium alloys, one or more sodium composite materials etc. in any suitable combination or permutation thereof. Again, the one or more anode active material(s) may be selected from the group consisting of: Li, Li—Mg, Li—Si, Li—Li₃N, Li—Li₂O, Li—LiFePO₄, Li-NMC (Li—NiₓMn_{y}Co_{z}O₂, where (x+y+z≈1)), Li-NCA (Li—NiₓCo_{y}Al_{z}O₂, where (x+y+z≈1)), Li—LiCoO₂, Na, Na—Sn, Na—Si, Na—C, or any suitable equivalent(s) or combination(s) thereof that would be appreciated by those having ordinary skill in the art upon reading the present disclosure.

Similarly, the ion-conducting material(s) may include any one or more materials selected from the group consisting of: Li₇La₃Zr₂O₁₂ (LLZO), LiAlO₂, Beta-Al₂O₃ (Li⁺), Li₆P₂S₅Cl, Li₆P₂S₅Br, Li₆P₂S₅I, Li₄Ti₅O₁₂, LiFePO₄, LiCoO₂, LiNiO₂, LiNi_{0.5}Mn_{0.1}Co_{0.1}O₂ (NMC811), LiNi_{0.33}Mn_{0.33}Co_{0.33}O₂ (NMC111), LiNi_{0.6}Mn_{0.2}Co_{0.2}O₂ (NMC622), Li₄Ti₅O₁₂ (LTO), LiVO₂ (LVO), SiO₂, SnO₂, NiO, one or more sodium super ionic conductors (NASICONs), NaN(SO₂F)₂, Na₃PS₄, Na₃SbS₄ ceramic, Na₂S—SiS₂ glass, and combinations thereof.

FIGS. 1A-1C are scanning electron micrograph (SEM) images of a three-dimensional (3D) composite anode, in accordance with one embodiment. As shown in secondary electron detector (SED) image 100 of FIG. 1A, lithium ion-conducting material or sodium ion-conducting material is present in the form of a plurality of particles 102 each independently having a diameter in a range from about 10 nm to about 10 μm. For example, ion-conducting particles (whether lithium or sodium ion-conducting) may be characterized by a diameter of about 10 nm, about 25 nm, about 33 nm, about 50 nm, about 75 nm, about 100 nm, about 125 nm, about 150 nm, about 175 nm, about 200 nm, about 250 nm, about 300 nm, about 333 nm, about 350 nm, about 400 nm, about 500 nm, about 600 nm, about 666 nm, about 750 nm, about 850 nm, about 900 nm, about 975 nm, about 999 nm, about 1,000 nm (1 μm), about 1.1 μm, about 1.25 μm, about 1.33 μm, about 1.5 μm, about 1.66 μm, about 1.75 μm, about 2 μm, about 2.5 μm, about 3.33 μm, about 5 μm, about 6.66 μm, about 7.5 μm, about 8 μm, about 9 μm, about 9.8 μm, about 9.9 μm, about 9.99 μm, about 10 μm, or any value within the broadly stated range of about 10 nm to about 10 μm, whether expressly recited above or falling between values expressly recited above, without departing from the scope of the inventive concepts presently disclosed.

The circled particle 102 is characterized by a diameter of about 5 μm, for example. Moreover, FIGS. 1A and 1B (a backscattered electron detector (BED) image, 110) demonstrate that the particles are substantially uniformly distributed throughout the 3D monolith along a horizontal axis thereof, while FIG. 1C, which shows a BED image 120 of the same structure shown in FIGS. 1A-1B, demonstrates that the lithium ion-conducting material (particles) are substantially uniformly distributed throughout the 3D monolith along a vertical axis thereof.

Accordingly, FIGS. 1A-1C collectively demonstrate a substantially homogenous distribution of lithium ion-conducting material throughout the bulk of the 3D monolith. As noted above, this homogenous distribution advantageously facilitates homogenous distribution of lithium ions throughout the structure, which in turn enables significantly improved cycling characteristics (including, but not limited to, longer cycle life, higher C-rate and Coulombic efficiency) of batteries employing such compositions as an electrode, particularly as the anode.

Moreover, the bright coloring of the lithium ion-conducting particles 102 shown in FIG. 1A is indicative of electrically insulating properties, which may advantageously prevent lithium plating above the 3D structure, and corresponding resistance to disadvantageous formation of a bi-layer structure as seen in conventional electrically conductive 3D compositions.

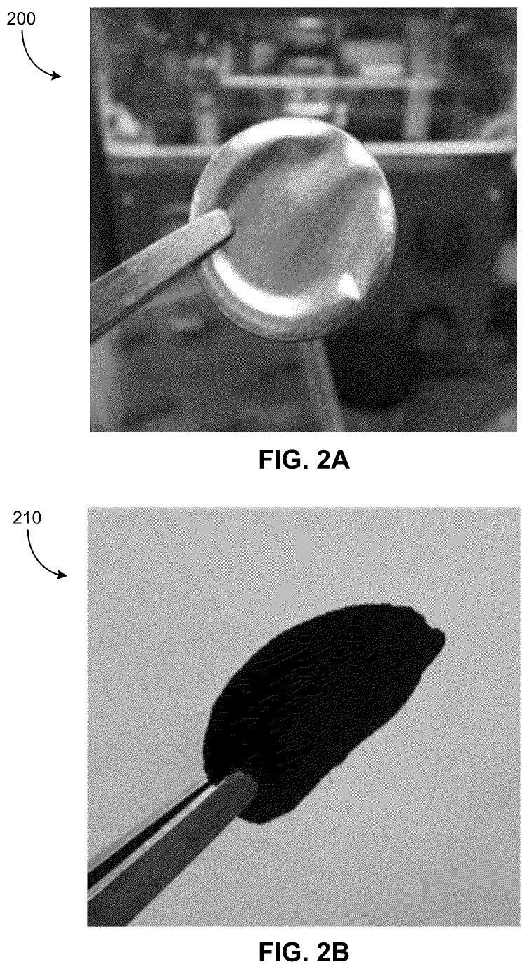

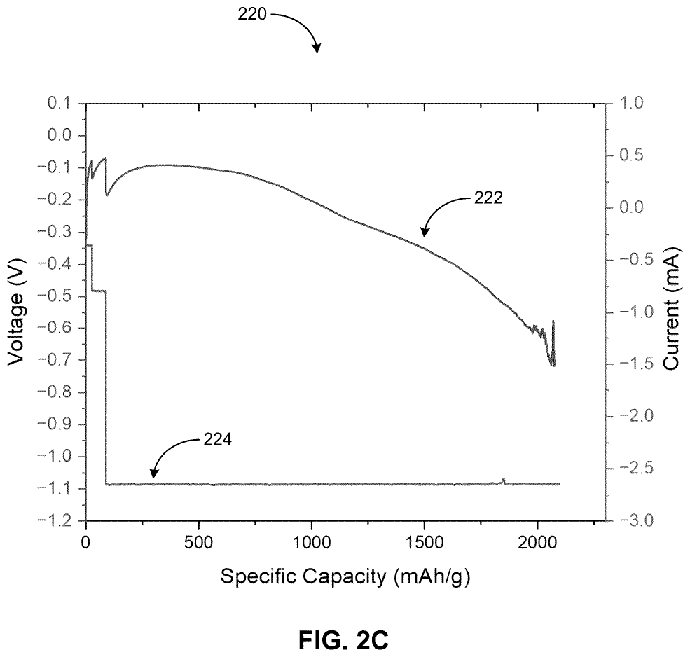

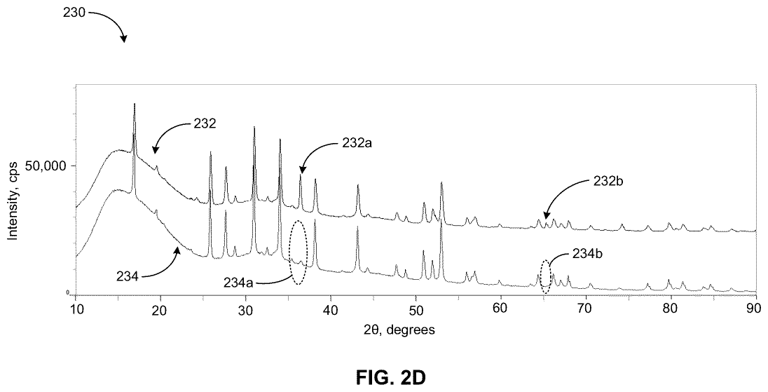

FIG. 2A is a photograph 200 of a pristine 3D composite anode, in accordance with one embodiment.

FIG. 2B is a photograph 210 of the 3D composite anode as shown in FIG. 2A, after stripping, in accordance with one embodiment. As can be seen from FIG. 2B, and confirmed experimentally, stripping removes nearly or completely all of the lithium present in the anode. After stripping, the volumetric change of the electrode is only about 14% (˜0.067 cm³/Ah) compared to the value of a pure lithium metal. The results indicate that the 3D structure was maintained after all lithium was stripped out.

FIG. 2C is a graph 220 showing voltage profiles of a symmetric cell including a 3D composite anode (curve 222) versus a symmetric cell including a lithium foil anode (curve 224), in accordance with one embodiment. These data were generated using a cell including 50 μl 0.4 M LiTFSI in DME/DOL/BTFE (50/25/25 in volume) with 2 w % LiNO₃ as the electrolyte. As shown in FIG. 2C, the electrode showed the low overpotential of ˜0.1 V at 1.33 mA/cm² with a low electrolyte amount (50 μL). The specific capacity is 2050 mAh/g, indicating near 100% lithium utilization in the 3D Li composite electrode.

FIG. 2D is a graph 230 showing X-ray diffraction (XRD) profiles of the 3D composite anode as shown in FIGS. 2A and 2B, before (curve 232) and after (curve 234) stripping, in accordance with one embodiment. As shown in FIG. 2D, the 3D composite anode after Li stripping (curve 234) showed almost no X-ray diffraction (XRD) peaks indicating presence of Li metal, as can be seen from the absence of peaks 232a and 232b (which respectively indicate presence of Li (110) and Li (211)) from curve 234 (see regions 234a and 234b). (Skilled artisans viewing FIG. 2D will appreciate that peaks other than 232a and 232b correspond to presence of lithium ion-conducting materials in the analyzed composition.)

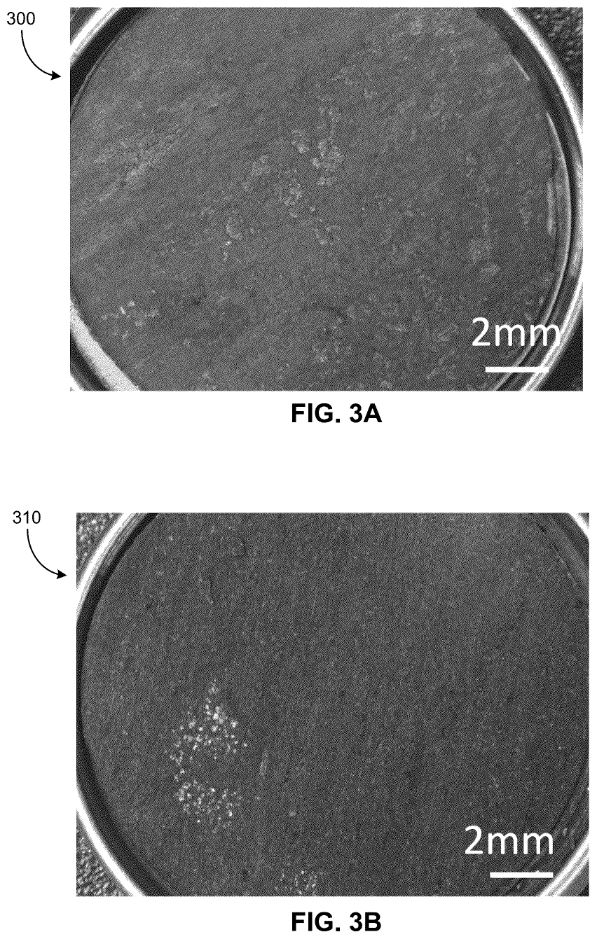

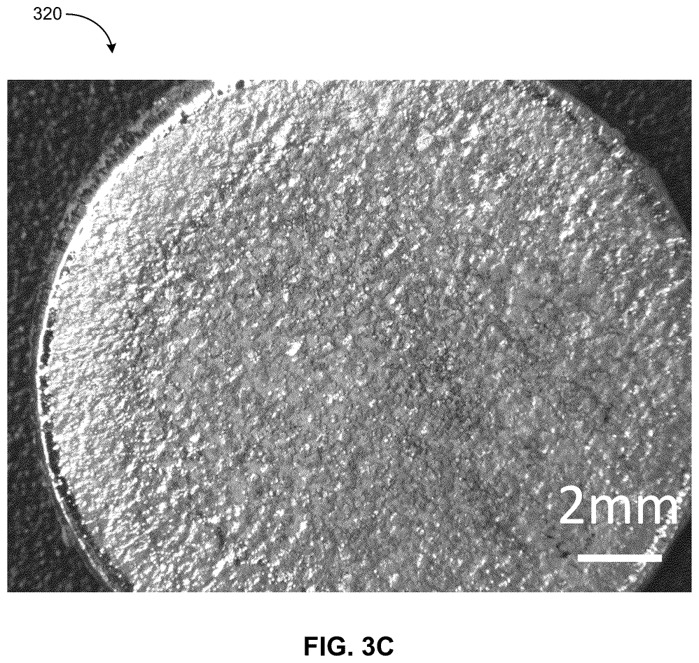

This demonstrates that the lithium was almost completely stripped out from the 3D network. The XRD results is consistent with the discharge capacity seen in FIG. 2C and microscope images shown in FIGS. 3A-3C, and shows almost 100% utilization of Li in the 3D composite anode.

FIGS. 3A-3C are images depicting surfaces of the composite electrode shown in FIGS. 2A-2B, according to one embodiment. In particular, FIG. 3A is a microscopic image 300 of a 3D composite electrode surface facing the current collector, in accordance with one embodiment, while FIG. 3B is a microscopic image 310 of a 3D composite electrode surface facing the separator, in accordance with one embodiment, and FIG. 3C is a microscopic image 320 of a lithium counter electrode surface facing the separator, in accordance with one embodiment.

As can be seen from FIGS. 3A-3C, the surfaces of the composite electrode facing the current collector (3A) and facing the separator (3B) show dark color, suggesting that all Li was stripped out from the 3D composite electrode. The Li plated surface of the counter electrode (3C) shows shining Li color, suggesting minimal dendrite formation after plating. The dendrite free surface suggests that the 3D composite anode provides substantially homogenous lithium ion flux on the counter electrode surface. Using the inventive 3D composite anode as described herein, sulfur cathode utilization is increased by reducing non-reactive area caused by uneven lithium ion flux in conventional Li metal cells employing planar lithium anodes.

As known in the art, high anode surface area (e.g., microporous scale) is associated with improved cycling stability, this configuration also tends to detriment cycling capacity. Surprisingly, although the inventive 3D composite anode structures and materials described herein are characterized by high surface area, the cycling characteristics of an exemplary Li—S battery with the inventive 3D composite anode remains associated with high cycling capacity.

Without wishing to be bound to any particular theory, the inventors propose the retention of desirable cycling characteristics in the exemplary Li—S battery with the inventive 3D composite anode may be attributed to alleviated parasitic side reaction between anode and electrolyte or polysulfides via 3D network protection. In addition, the high surface area and homogenous lithium ion flux through the 3D network may also minimize formation of lithium Li dendrites and/or dead lithium formation.

Accordingly, the inventive 3D composite anode described herein provides an elegant solution to achieve high power lithium-metal batteries (especially for Li—S batteries). In some approaches, approximate 100% utilization of Li in the 3D network (e.g., via the presence and positioning of lithium ion-conducting materials) can be achieved with correspondingly small volumetric change (˜360 μm/Ah), guaranteeing high energy density. The illustrative Li—S batteries with inventive composite anode structures as described herein can deliver high specific capacity (˜450 mAh/g) with high sulfur loading (7.5 g/cm²). This represents an approximately 30% improvement compared to otherwise similar batteries employing with a planar lithium anode. The facile preparation methods of the 3D composite anode also suggest good scalability and cost-effectivity.

FIG. 6A is a simplified schematic of a planar electrode 600, in accordance with one embodiment.

FIG. 6B is a simplified schematic of a monolithic 3D composite electrode 610, in accordance with one embodiment.

FIG. 6C, by way of comparison to the inventive structures for 3D composite anodes described hereinabove, FIG. 6C shows a cross-sectional view of an anode 620 characterized by a core-shell structural arrangement, where portions of the shell may, but need not necessarily, penetrate into the core and form ionically conductive pathways therethrough.

FIG. 6D similarly depicts a cross-sectional view of an anode 630 characterized by a core-shell structural arrangement, but in which the shell is a distinct structure that forms a “cage” surrounding the core without penetrating into the core.

In both FIGS. 6C and 6D, the anode 620, 630 comprises the core 622 which includes one or more anode active materials, and (optionally) one or more ion-conducting materials homogenously distributed therethrough. The core 622 may be a (micro)porous, three-dimensional monolith having any of the structural, compositional, or performance characteristics described hereinabove, except as expressly stated otherwise in the instant descriptions of FIGS. 6C and 6D.

In accordance with the embodiments of FIGS. 6C and 6D, the core is surrounded by a shell formed from a plurality of particles 624 of one or more ion-conducting materials, including any combination of ion-conducting materials described herein without limitation. The ion-conducting material(s) of the particles 624 form a plurality of ionically conductive channels (black dotted lines) ionically and/or electrically coupling the core of the anode to the environment external thereto (e.g., to an electrolyte in or of an electrochemical cell).

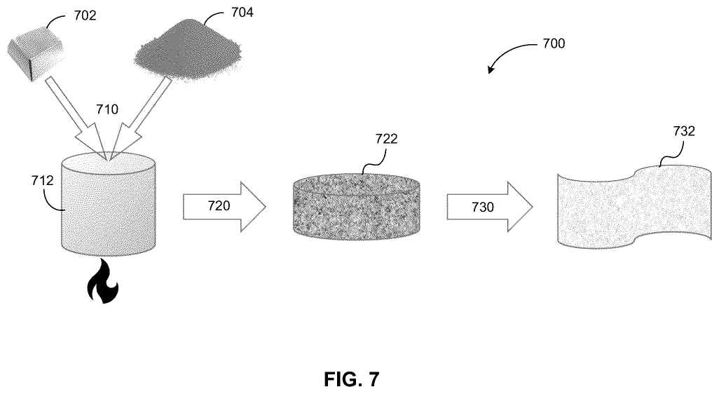

While in FIG. 6C it can be seen that some of the particles 624 and corresponding pathways penetrate into the interior region or volume of the core, in FIG. 6D no such penetration is present. Instead, according to anode 630 the particles 624 remain arranged around the outer circumference of the core 622, effectively forming a “cage” surrounding the core 622. With less ionically conductive particles 624 in FIG. 6D than in FIG. 6C, the gravimetric and volumetric energy density of the 3D composite anode is advantageously much higher. The cage may be formed from one or more layers of the particles, or agglomerates thereof that form during the melt-and-infusion-based process described in greater detail below with respect to FIG. 7, or may comprise a substantially continuous structure surrounding the core 622. Preferably, the cage is a physically distinct structure from the core 622, which may be in contact with outer surface(s) of the core 622 but does not extend into an interior volume thereof. Regardless, the cage shown in FIG. 6D similarly functions as a continuous, ion-conductive network ionically coupling the core 622 to the environment external to the anode 630.

In addition, FIG. 6C depicts an implementation in which the anode 620 has an optional support structure 626 disposed within the core, while FIG. 6D omits this optional component. As will be appreciated by persons having ordinary skill in the art upon reading the instant disclosure, the optional support structure 626 may be a porous support comprising graphene or another appropriate electrically conductive material, such as graphite, graphene oxide, 3D graphene, or any suitable equivalent(s) or combination(s) thereof. Moreover, the optional support structure 626 and may function as a current collector for electrochemical cells implementing the inventive anode structure 620. In other embodiments such as anode 630 shown in FIG. 6D, the core 622 comprises material(s) and is structurally arranged to provide mechanical support to the core 622, to carry current away from the anode 630 (e.g., to a battery tab, connector, or other suitable structure as would be understood by a person having ordinary skill in the art upon reading the present descriptions).

In various approaches, anodes 620, 630 and equivalent variants thereof may be characterized by a substantially spherical structure having a total diameter in a range from about 1 μm to about 200 μm. Similarly, the core 622 may be characterized by a substantially spherical shape, a diameter in a range from about 100 nm to about 200 μm, and a surface area to volume ratio in a range from about 6×10⁵ cm to about 149 cm. The shell formed of particles 624 surrounding the core 622, particularly according to embodiments where the shell is in the form of a “cage” as shown in FIG. 6D, may be characterized by a thickness in a range from about 10 nm to about 10 μm. As described above for the general 3D monolithic structure, particles 624 may be characterized by a diameter in a range from about 10 nm to about 10 μm.

FIG. 7 is a simplified schematic flow gram 700 showing steps of a process for fabricating a 3D composite electrode (e.g., a Li 3D composite electrode as a more specific example), in accordance with one embodiment. As shown in FIG. 7, and according to some embodiments in a first operation 710 anywhere from about 1 wt % to about 99 wt % of a lithium-based material (e.g., lithium metal, lithium alloy, lithium composite, or combination thereof as described herein) is combined with the balance (e.g., from about 1 wt % to about 99 wt %) of a powderized lithium ion-conducting material 704.

In other approaches, particularly for forming core/shell structures such as shown in FIGS. 6C and 6D, and described herein above, the composition may include anywhere from about 10 wt % to about 90 wt %, e.g., about 10 wt %, about 15 wt %, about 20 wt %, about 25 wt %, about 33 wt %, about 40 wt %, about 45 wt %, about 50 wt %, about 55 wt %, about 60 wt %, about 66 wt %, about 70 wt %, about 75 wt %, about 80 wt %, about 90 wt %, etc. of active anode material(s) (to form the core 622), anywhere from about 10 wt % to about 90 wt %, e.g. about 10 wt %, about 15 wt %, about 20 wt %, about 25 wt %, about 33 wt %, about 40 wt %, about 45 wt %, about 50 wt %, about 55 wt %, about 60 wt %, about 66 wt %, about 70 wt %, about 75 wt %, about 80 wt %, about 90 wt %, etc. of ion-conducting material(s) (to form the particles 624 of the shell), and optionally up to about 5 wt %, e.g., 0 wt %, about 0.25 wt %, about 0.33 wt %, about 0.5 wt %, about 0.66 wt %, about 0.75 wt %, about 1 wt %, about 2 wt %, about 2.5 wt %, about 3.33 wt %, about 4 wt %, about 5 wt %, etc. of one or more electrically conductive materials such as crystalline carbon, graphite, 3D graphene, etc. if a support structure 626 is to be present in the final product. Again, this support structure 626, while optional, may provide mechanical support and/or electrical pathways between the spherical anode 620 and an environment external thereto.

Of course, it will be appreciated that the respective amount of anode active material(s), ion-conducting material(s), and/or electrically conductive material(s) may be varied within the above broad ranges in any manner constrained thereby without departing from the scope of the inventive concepts presented herein.

The resulting mixture is homogenized to form a liquid composite, e.g., via heating in a crucible, using a hotplate or furnace, etc. with stirring or agitation at a suitable temperature and for a suitable duration, e.g. at a temperature in a range from about 200 C to about 650 C for a duration from about 10 minutes to about 12 hours, as will be understood by persons having ordinary skill in the art upon reading the present disclosure.

In operation 720, the resulting homogenous liquidous composite is poured into a graphite mold, forming a 3D monolith comprising the lithium-based material with lithium ion-conducting material homogenously distributed throughout.

Optionally, fabrication may include an extrusion and/or rolling process, or other equivalent in operation 730, in order to engineer the final structure of the resulting electrode. According to the illustrative approach shown in FIG. 7, the resulting structure is a thin foil having a thickness in a range from about 20 μm to about 500 μm.

For instance, in one exemplary approach 5 g of a lithium-based material 702 (e.g., a Li—Mg alloy), 5 g of a lithium ion-conducting material 704 (LLZO), and 0.2 g of Al₂O₃ nano powder or nano fiber (serving as wetting agent) were added in a crucible on the hotplate at 450° C. with stirring for 30 min. Then the homogenized liquidous composites were poured out into a graphite mold. Afterwards, extruding and rolling were conducted to make a thin foil (˜150 μm thickness).

Skilled artisans will appreciate that the fabrication process utilized in accordance with the presently disclosed inventive concepts, which generally involves melting an alloy, adding ionically conductive materials (e.g., in the form of a nanopowder) into the melt, and infusing the mixture until the ionically conductive materials form particle agglomerates substantially homogenously distributed throughout the bulk of the melt material to form a continuous ion-conducting network therethrough, are substantially distinct from, and produce unique structures and compositions relative to, conventional fabrication techniques described hereinabove which generally involve etching or dealloying a monolithic structure (e.g. an alloy of copper, nickel, iron, etc. or a high-surface area carbonaceous material such as activated carbon, graphene oxide, etc.) to form a “foam” or other very high surface area structure, followed by deposition (e.g., chemical vapor deposition (CVD), atomic layer deposition (ALD), sputtering, etc. as known in the art) resulting in a final product often characterized as a “stable foam”. For example, inventive compositions formed using the melt-and-infuse fabrication techniques described herein are generally characterized by substantially less porosity and surface area than conventional compositions fabricated using the conventional etch-and-deposit techniques. Similarly, inventive compositions formed using the melt-and-infuse fabrication techniques exhibit substantially increased active density, and much larger particle size (e.g. on the order of about 17 nm to about 10 μm), especially with reference to particles of the ion-conducting material included in the composition.

Accordingly, the inventive concepts presented herein represent substantial improvements to performance of lithium-based batteries, and address many conventional problems associated with the use of lithium-based materials, particularly in anode compositions. These improvements are described without limitation hereinabove, and principally include high utilization (˜100%) of lithium or sodium in the 3D composite anode, delivering ˜2000 mAh/g (for a Li 3D composite anode); low volumetric changes, e.g., only 14% relative to pure Li anodes; high-rate capability, e.g., an improvement on the order of about 30% improvement at 1.0 C compared to an otherwise identical planar anode; and good cycling stability (e.g., about 0.06% capacity decay per cycle).

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

According to various embodiments, the inventive anode structure and composition disclosed herein may exhibit advantageous performance characteristics including but not limited to: a specific capacity of at least about 450 mAh/g; a capacity decay of about 0.1% or less per cycle; a cycling capacity of at least about 600 mAh/g at a fifth charge cycle; a capacity utilization of at least about 75% relative to a discharge capacity at C/3; or any permutation or combination thereof.

In various approaches, the inventive structures, compositions, configurations, etc. described herein may be implemented in electrochemical cells of various types for practical utilization in a wide variety of applications. Without limitation, exemplary electrochemical cell configurations that may utilize any combination of features described herein, may be in the form of a pouch, a coin, a prismatic cell, a cylindrical configuration, or any suitable equivalent(s) thereof that would be appreciated by those having ordinary skill in the art upon reading the present disclosure.

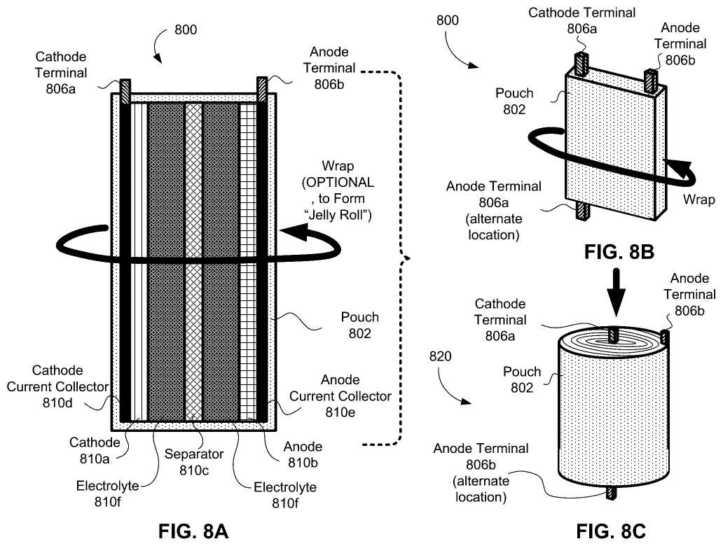

With reference to electrochemical cells having a pouch cell arrangement 800, and as shown according to exemplary embodiments in FIGS. 8A-8C, an electrochemical cell includes a cathode 810a and an anode 810b positioned on opposing sides of the pouch cell arrangement 800, and separated (physically and/or chemically) by a separator 810c. The anode 810c and cathode 810a are electronically coupled via an electrolyte 810f present in the pouch cell arrangement 800. Moreover, each electrode is electronically coupled to an external environment of the pouch cell arrangement 800 via a current collector and corresponding terminal, i.e. the cathode 810a is coupled to the external environment via cathode current collector 810d and cathode terminal 806a, while the anode 810b is coupled via anode current collector 810e and anode terminal 806b. The foregoing structures are enclosed, encased, or otherwise spatially fixed and contained via a pouch 802 surrounding the components.

The pouch 802, according to various embodiments, may take any suitable form that would be understood by those having ordinary skill in the art upon reading the present disclosure, such as a wrapping, a coating, an enclosure (soft or hard), a compressive structure (such as a metal band or mesh), etc. as would be understood by those having ordinary skill in the art upon reading the present disclosure.

Moreover, as shown in FIG. 8B, the anode terminal 806b and cathode terminal 806a extend through pouch 802, providing electronic coupling between interior and exterior environments of the pouch cell arrangement 800. Note the anode terminal 806b may alternatively be positioned on a same side, or an opposite side, of the pouch cell arrangement 800 relative to the cathode terminal 806a. Moreover, the relative position of the anode terminal 806b and the cathode terminal 806a may be switched relative to the arrangement shown in FIGS. 8B and 8C, according to alternative implementations and without departing from the scope of the presently described inventive concepts.

As noted in FIGS. 8A and 8B, the illustrative pouch cell arrangement 800 may be wound around, e.g., its longitudinal axis, to form a spiral, folded, pleated, rolled, or otherwise at least partially overlapping configuration of the above-referenced electrochemical cell components. In preferred implementations, winding the pouch cell arrangement 800 yields a configuration known as a “jellyroll”, Shown schematically in FIG. 8C.

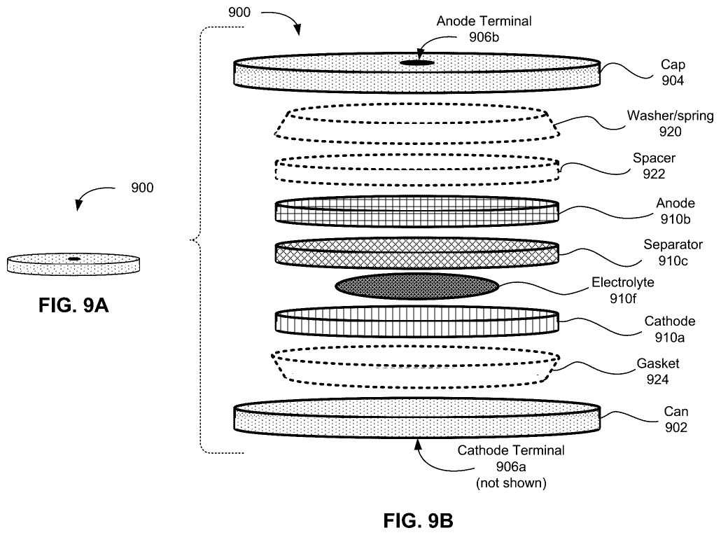

Turning now to FIGS. 9A and 9B, which depict a simplified schematic of an electrochemical cell configured according to a coin cell arrangement 900 is aptly named for its substantially flat, cylindrical shape as shown in FIG. 9A. According to various embodiments, the cylindrical cell arrangement 900 includes a can 902 and cap 904 which protect the components placed therein from mechanical damage, chemical damage (e.g. corrosion, oxidation, etc.) electrical damage, etc. and also prevent leakage of compounds within the cylindrical cell arrangement 900 into the environment.

Coupled to the cap 904 is an anode terminal 906b, and likewise coupled to the can 902 is a cathode terminal 906a (not shown in FIG. 9B). Preferably, these terminals have a composition suitable for conducting electricity generated within the coin cell arrangement 900 to an appropriately connected or coupled output, and may be inserted into a circuit to provide power thereto, as would be appreciated by those having ordinary skill in the art upon reading the present descriptions. Exemplary compositions suitable for use in cathode terminal 906a and anode terminal 906b include electrically conductive metals, such as copper, nickel, etc. as known in the art, electrically conductive carbonaceous materials, such as graphene, etc. as known in the art, or any other suitable equivalent thereof that would be appreciated by a skilled artisan upon reading the present disclosures.

Turning now to FIG. 9B, a plurality of components that may be included in a coin cell arrangement 900 are shown according to an exploded view consistent with various embodiments of the presently described inventive concepts. It shall be appreciated that components such as washer/spring 920, spacer 922, and gasket 924, represented by dotted outlines, are optional and may, but need not, be included in accordance with the inventive concepts disclosed herein. However, it shall also be appreciated that, depending on the intended application for the coin cell arrangement 900, washer/spring 920, spacer 922, and/or gasket 924 may advantageously convey mechanical strength, or convey advantageous electrical properties, on the coin cell arrangement 900. For instance, washer/spring 920 and/or gasket 924 may help secure the other depicted components in place, facilitating desired operation of the coin cell arrangement 900. Similarly, spacer 922 may cushion the anode 910b from friction or compressive force from the washer/spring 920, and/or be formed from a material that facilitates conduction of heat and/or electricity from within the coin cell arrangement 900 to the anode terminal 906b, according to the configuration shown in FIG. 9B. Of course, those having ordinary skill in the art will appreciate various advantages that may be realized via inclusion of washer/spring 920, spacer 922, and/or gasket 924, in various implementations, based on knowledge generally available at the time of the present disclosure's filing date.

With continuing reference to FIG. 9B, illustrative coin cell arrangement 900 features internal components including an anode 910b positioned toward an opposing end of the coin cell arrangement as a cathode 910a, with a separator 910c and electrolyte 910f positioned therebetween. As with all electrochemical cell arrangements shown in FIGS. 8A-11 and consistent with corresponding descriptions thereof provided herein, the anode 910b, cathode 910a, separator 910c, and electrolyte 910f may each be characterized by any composition as known in the art or as described herein that a skilled artisan would appreciate as suitable for the respective function thereof in an electrochemical cell, upon reading the present disclosure and without departing from the scope of the presently described inventive concepts. Several such exemplary compositions are provided hereinbelow, and others may be set forth elsewhere in the detailed descriptions of the inventive concepts instantly set forth. Unless expressly admitted as being known in the art, it shall be understood that any such exemplary composition described for any of the components of electrochemical cell arrangements 8A-11 is not admitted as being so well-known, but rather is considered part of the inventive concepts presented herein.

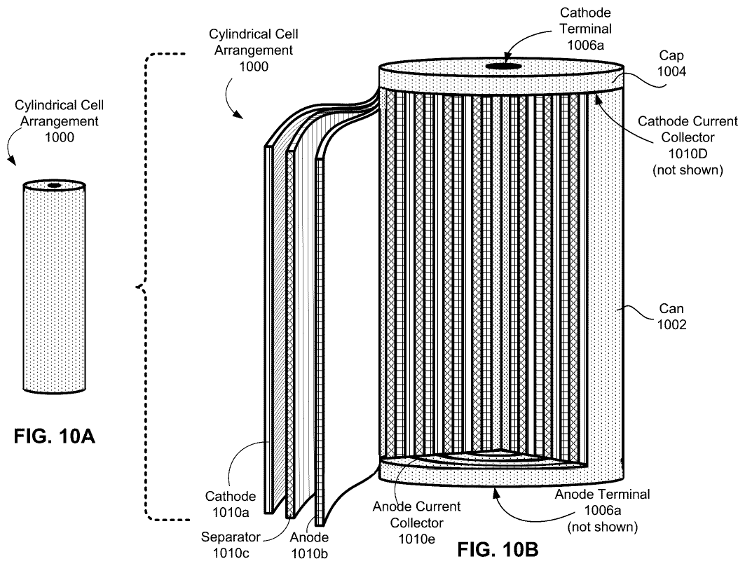

In other approaches, electrochemical cells may be characterized by a cylindrical cell arrangement 1000, e.g., as shown according to illustrative implementations in FIG. 10A (external view) and 10B (cut-out view), includes a can 1002 and a cap 1004 that contain and protect other components internal to the cylindrical cell configuration, in similar manner as described herein regarding coin cell arrangements such as coin cell arrangement 900 shown in FIGS. 9A and 9B. Also similar to other arrangements described herein, the cap 1004 and can 1002 each respectively include a terminal configured to conduct electricity generated within the cylindrical cell arrangement 1000 to an external environment, output device electrically coupled to the cylindrical cell arrangement 1000, etc., according to various embodiments and as would be appreciated by those having ordinary skill in the art upon reading the present disclosure. As shown in FIG. 10B, cap 1004 includes a cathode terminal 1006a, while can 1002 includes an anode terminal 1006b (not shown in FIG. 10B), positioned at substantially opposite ends of the cylindrical cell arrangement 1000. Of course, the relative position of the cathode terminal 1006a and anode terminal 1006b may be swapped, according to alternative embodiments of the cylindrical cell arrangement 1000.

With continuing reference to FIG. 10B, the illustrative cylindrical cell arrangement 1000 includes similar components as described herein with reference to other electrochemical cell arrangements, but structurally arranged in a unique manner. Most notably, while the cathode(s) 1010a and anode(s) 1010b are spatially separated by separator(s) 1010c, there are a plurality of such structures arranged in substantially laminar configuration and wound around a central longitudinal axis of the cylindrical cell arrangement 1000. In this manner, the cathode(s) 1010a and anode(s) 1010b are not positioned proximate to opposing ends of the cylindrical cell arrangement 1000 as is the case for pouch cell arrangement 800 and coin cell arrangement 900, but rather present throughout a volume of the cylindrical cell arrangement 1000. Regardless, consistent with pouch cell arrangement 800, the cylindrical cell arrangement 1000 includes a cathode current collector 1010d (not shown in FIG. 10B) and an anode current collector 1010e positioned at opposing ends of the cylindrical cell arrangement 1000 and electrically coupled to a corresponding terminal (i.e., either cathode terminal 1006a or anode terminal 1006b), as would be understood by those having ordinary skill in the art upon reading the present disclosures.

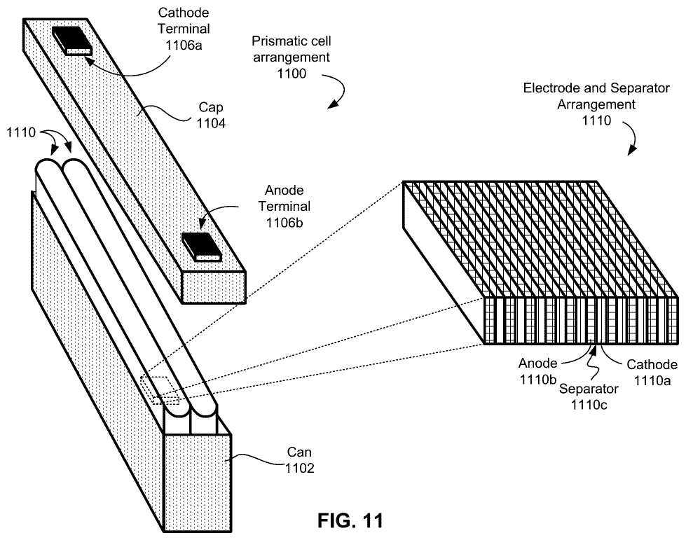

Now regarding FIG. 11, a simplified schematic of an electrochemical cell embodied in a prismatic configuration 1100 is shown, according to one aspect of the presently disclosed inventive concepts. As with other electrochemical cell arrangements described hereinabove, the prismatic cell arrangement 1100 includes a can 1102 and a cap 1104. Unique to the prismatic cell arrangement 1100, the can 1102 and cap 1104 as shown in FIG. 11 are substantially rectangular cuboidal in shape, although those having ordinary skill in the art will appreciate that a unique advantage of prismatic cell arrangements as contemplated herein is nearly unlimited flexibility with respect to the spatial configuration of the can 1102 and cap 1104. The sole limitation on such spatial configuration is the ability to fully enclose and contain the internal components, shown according to one exemplary embodiment with reference to electrode and separator arrangement 1110. This flexibility, in large part, is due to implementation of electrode and separator arrangements 1110 characterized by a laminar structure including anode(s) 1110a and cathode(s) 1110a physically and/or chemically separated by separator(s) 1110c. While the particular electrode and separator arrangement 1110 shown in FIG. 11 is a multi-layered structure (e.g., composed of a series of thin films deposited sequentially one onto the other) those having ordinary skill in the art will appreciate that according to various implementations the components of the electrode and separator arrangement 1110 (which may include components other than anode 1110b, cathode 1110a, and separator 1110c without departing from the scope of the presently disclosed inventive concepts) may be arranged in a “rolled” configuration such as shown in FIGS. 8C and 10B, or in a folded configuration, a pleated configuration, or any other configuration in which at least portion(s) of the components of the electrode and separator arrangement 1110 at least partially overlap themselves, one another, or both. Furthermore, combinations of overlapping arrangements may be implemented in electrode and separator arrangement 1110 without departing from the scope of the presently disclosed inventive concepts.

Returning to the cap 1104 of exemplary prismatic cell arrangement 1100 shown in FIG. 11, in one illustrative implementation a plurality of terminals including cathode terminal 1106a and anode terminal 1106b are disposed on an external surface of the cap 1104 and electrically coupled to the electrode and separator arrangement 1110, e.g. via one or more current collectors (not shown in FIG. 11) using any suitable means and/or mechanisms that would be understood by those having ordinary skill in the art upon reading the instant descriptions.

Several exemplary electrochemical cell arrangements have been shown and described with reference to FIGS. 8A-11, and shall be understood as illustrative rather than limiting on the scope of the inventive concepts presented herein. Moreover, certain arrangements are depicted as including or omitting certain components not expressly shown or described with reference to other arrangements (such as the washer/spring 820, spacer 822, gasket 824, electrolyte 810f, current collectors 810d and 810e, shown with reference to FIG. 8A but not expressly shown or described with reference to other arrangements set forth herein. Despite the particular components shown in FIGS. 8A-11, it shall be understood that any electrochemical cell arrangement, whether in accordance with FIGS. 8A-11 or according to a different electrochemical cell arrangement, may include any suitable combination of components described with reference to any single Figure, or components not shown in any of the Figures, but which would be appreciated as suitable for creating a functioning electrochemical cell by a person having ordinary skill in the art upon reading the instant descriptions.

Of course, the various exemplary embodiments of electrochemical cells arranged according to different configurations shown in FIGS. 8A-11 and described hereinabove are provided for illustrative purposes, and should not be interpreted as limiting on the scope of electrochemical cells in which the inventive anode structures and compositions presently disclosed may be implemented. For instance, in various approaches different electrochemical cell configurations may be used together, in any combination, to provide power to one or more machines.

Moreover, the exemplary electrochemical cell configurations described hereinabove may be modified in any suitable manner known in the art without departing from the scope of the inventive concepts described herein. For instance, various components shown above in FIGS. 8A-11 may be modified, substituted, omitted, supplemented, etc. in any manner that a skilled artisan reading the present disclosure would appreciate as suitable for producing a working electrochemical cell, without extending beyond the scope of the presently described inventive concepts.

For instance, according to various embodiments, electrochemical cells implemented in accordance with the presently described inventive concepts may include one or more (preferably at least two) electrodes, which may individually be characterized as anode(s), or cathode(s), e.g., according to electrochemical function within the overall cell, and may be formed from any suitable material(s) known in the art and appreciated, upon reading the present disclosure, as suitable for use in combination with other structures and compositions in the exemplary electrochemical cell and in accordance with the inventive concepts provided herein.

In some approaches, either or both electrode types may be configured in the form of a three-dimensional, monolithic structure that is “free-standing”. In other words, the “free-standing” electrode is “structurally self-supporting”, such that no separate substrate, framework, scaffold, foam, matrix, current collector, supporting fluid, etc. is necessary for the monolith to support its own weight and maintain defining physical characteristics (e.g., density, volume, porosity, physical dimensions, shape, chemical composition, etc.) when deposited, positioned, or otherwise placed in a working environment such as an electrochemical cell. Of course, the inventive concepts presented herein should not be interpreted as being limited in any way to inclusion of or requirement for “free standing” electrode(s), but should be understood as allowing for such structures where advantageous to the specific application(s) or intended utility for the inventive electrochemical cell of interest.

Where a “free standing” electrode structure is implemented, corresponding electrochemical cells may, and preferably do, omit a distinct current collector (or at least a distinct anode current collector), according to select implementations. Indeed, even where no “free standing” electrode structure is present, electrochemical cells in accordance with the inventive concepts described herein may still omit a distinct current collector structure or component.

For instance, according to certain implementations, the electrode itself may serve as the current collector, or the separator(s) may serve as the current collector, in addition to fulfilling additional functions described herein with respect to the separator, such as physically, chemically, electrically, etc. segregating various components of the electrochemical cell from one another to avoid undesirable chemical reactions, physical phenomena, etc. as would be understood by a person having ordinary skill in the art upon reading the present disclosure. Again, the inventive concepts presented herein shall be understood as including, but not requiring, omission of distinct current collector components, according to various embodiments.

Accordingly, electrodes of the illustrative electrochemical cell implementations may be distinct structures, such as three dimensional monoliths, which may optionally be porous, have surface(s) thereof functionalized in order to enhance, suppress, or otherwise modify functional characteristics thereof (such as permeability, reactivity, etc. to select chemical species present within the electrochemical cell) without limitation. Electrodes may optionally or additionally include indeterminate structures, such as solutions that exhibit functional characteristics of monolithic electrode structures, but are present partially or wholly in the form of a solution. Further still, electrodes may be physically arranged in various configurations, such as thin films which may be sprayed or deposited on a suitable substrate; a one or more (flat) layers which may be sprayed or deposited on a suitable substrate or as free-standing structures; as a plurality of rows and/or channels (e.g., as may be formed in a suitable electrode material, or as may be formed as a result of stacking various layers of an electrochemical cell, rolling a multilayered electrochemical cell, etc.) as would be understood by those having ordinary skill in the art upon reading the present disclosure.

Optionally, electrodes may be coated with a protective layer designed to facilitate or mitigate predetermined chemical or physical interactions with other components of the electrochemical cell, such as reactions that consume electrode active material, form dendritic structures extending from the electrode, etc. as would be understood by those having ordinary skill in the art upon reading the present disclosure. In like manner, an electrode may include a plurality of particles (e.g. of active material) dispersed within or throughout the volume of a binder such as a polymer matrix, and the binder may be or include material(s) that facilitate or mitigate desired or undesired interactions within the electrochemical cell, respectively. In still more approaches, electrolyte(s) may be operatively, chemically, or electrically coupled to a membrane or membrane(s) configured (e.g., according to physical characteristics such as porosity, lack of porosity, spatial arrangement, surface area, etc., or chemically configured, e.g. according to chemical composition, specific functionalization (e.g., of surface(s) of the membrane), etc.) to isolate the electrolyte and/or chemical species formed or derived therefrom from other components of the electrochemical cell.

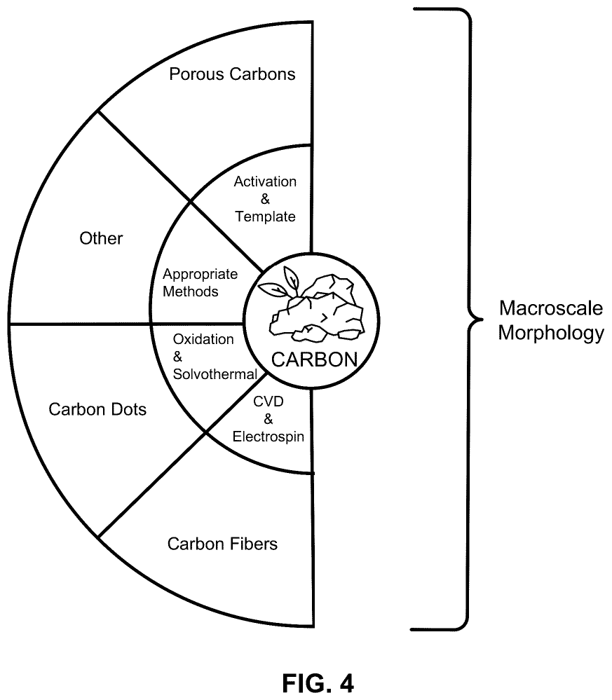

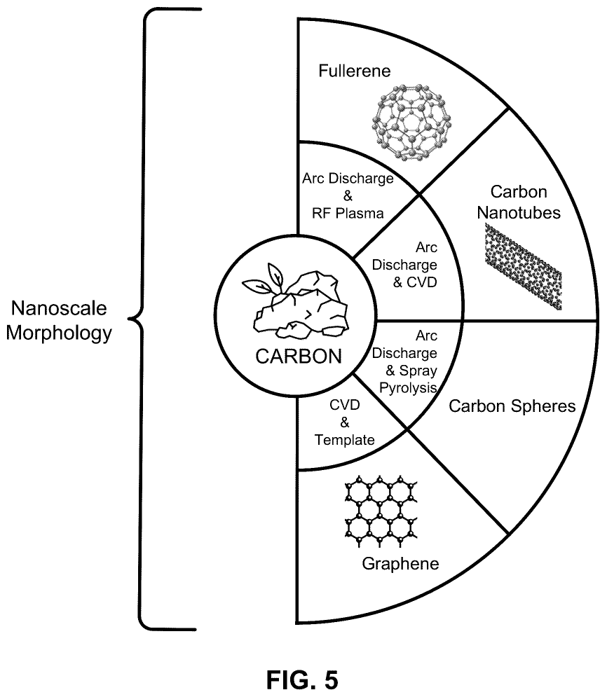

In particularly preferred approaches, electrodes may include one or more carbonaceous materials such as shown in FIGS. 4 and 5 and described in greater detail hereinbelow.

It shall be appreciated that electrolytes in accordance with the presently disclosed inventive concepts may have any suitable chemical composition that would be understood by a person having ordinary skill in the art taking into consideration the particular context of the electrochemical cell, e.g., the chemical composition and structural arrangement of various other components included in the electrochemical cell.

Similarly, electrolyte(s) present in various electrochemical cells may be in liquid form, may be or include solid state electrolyte composition(s), may be or include gel-phase or gel-based electrolytes (such as gel polymer electrolytes), or any combination thereof that would be appreciated by those having ordinary skill in the art upon reading the present disclosure. Similarly, electrolytes may include semi-solid compositions such as gels, slurries, suspensions, etc. as would be appreciated by those having ordinary skill in the art upon reading the instant disclosure.

Separator(s), which may also be omitted in accordance with certain aspects of the inventive concepts described herein, may be or include any suitable composition or structure known in the art and which skilled artisans reading the present disclosure will appreciate are compatible with the inventive compositions and/or structures described herein. For instance, separator(s) may include impermeable, solid structures, semi-permeable membranes, selectively permeable compositions (i.e., compositions that are permeable to one or more predetermined chemical species, but impermeable or substantially impermeable to select, or all, other chemical species, according to various embodiments). For example, separators may be configured to physically, chemically, electrically, or otherwise functionally separate or segregate different components of the electrochemical cell from one another in order to avoid undesirable chemical reactions (such as parasitic reactions between electrolyte or derivatives thereof and electrodes, polysulfide shuttling, dendrite formation, etc. as would be understood by those having ordinary skill in the art upon reading the instant descriptions).

In addition, the exemplary electrochemical cells, in any configuration described herein or equivalents thereof that would be appreciated by those having ordinary skill in the art upon reading the instant disclosure, may include one or more mechanisms for mitigating or preventing polysulfide shuttling, dendrite formation, parasitic reactions between electrode(s) and electrolyte(s) (as well as species formed or derived from electrodes or electrolytes during operation of the electrochemical cell), or other chemical species present in the electrochemical cell environment. These mechanisms may be inherent to one or more of the exemplary structures described hereinabove (e.g., electrodes, separators, electrolytes, etc.), or may be specifically configured via specific modification, functionalization, structural arrangement, etc. of the particular components of the electrochemical cell. Any such characteristics, whether inherently present or specifically configured, are described in greater detail herein in accordance with various exemplary embodiments of the inventive concepts presently disclosed.

From the foregoing general descriptions and corresponding drawings, skilled artisans reviewing the present application will appreciate that, according to different implementations, electrochemical cells as described herein include a variety of components which each have a specific, core role in function of the electrochemical cell as a whole (e.g., electrodes facilitating electrical contact between electrolyte and an environment external to the electrochemical cell; separators serving to isolate or segregate various components, chemical species, etc. from one another within the electrochemical cell environment; and electrolyte facilitating charge transfer between electrodes of the electrochemical cell), the various components may optionally serve or convey one or more additional functions to the electrochemical cell. For instance, and as mentioned above, electrodes or separators may serve, in addition to their respective core roles, as current collectors, allowing omission of separate (often heavy, metal) structures dedicated to collecting current generated by the electrochemical cell.

In various aspects, any one or more component(s) of the electrochemical cell arrangements described herein may include one or more carbonaceous materials, including but not limited to those shown in FIGS. 4 and 5. For example, certain components may include carbonaceous materials, carbonaceous materials may be included in addition to the various components shown and described with reference to FIGS. 8A-11, or both, as would be appreciated by those having ordinary skill in the art upon reading the present disclosures. In myriad embodiments, exemplary carbonaceous materials may include, without limitation, carbon black, carbon nano-onions (CNOs), necked CNOs, carbon nanospheres, graphite, pyrolytic graphite, graphene, graphene nanoparticles, graphene platelets, three-dimensional (3D) graphene, graphene oxides, fullerenes, hybrid fullerenes, single-walled nanotubes, multi-walled nanotubes, carbon dots, carbon spheres, porous carbons, carbon fibers, etc. as would be understood by skilled artisans upon reading the present descriptions. Additional details regarding the fabrication of select carbonaceous materials and characteristics thereof, particularly those shown in FIGS. 4 and 5, are provided by Li, et al. “Synthesis, modification strategies and applications of coal-based materials”, Fuel Processing Tech., 230:1, 107203 (June 2022) (https://doi.org/10.1016/j.fuproc.2022.107203).

Moreover, the exemplary components of electrochemical cells described hereinabove, particularly as shown in FIGS. 8-11, may be present in a single cell “stack” (e.g., two opposing electrodes with corresponding separator, electrolyte, etc. arranged therebetween) or in a repeating (e.g., laminar) structure, according to various embodiments. A simplified repeating structure may, for example, include a first cathode (optionally coupled to a first cathode current collector) at one end of the electrochemical cell, which is immediately adjacent to a first electrolyte, which in turn is immediately adjacent to a first separator, which in turn is immediately adjacent to a second electrolyte, which in turn is immediately adjacent to a first anode (optionally coupled to a first anode current collector) positioned toward an opposing end of the electrochemical cell as the first cathode, collectively forming a single electrochemical cell layer. The repeating structure may further comprise additional electrolyte, separator, and electrode structures in a similar manner to form a multilayered, repeating pattern within the resulting electrochemical cell.

Whether including repeating structures or not, in various approaches, electrochemical cells may be manipulated, configured, arranged, etc. during fabrication of a larger structure (such as a battery). For instance, and as will be appreciated by those having ordinary skill in the art upon reviewing the inventive concepts described herein, in some approaches an electrochemical cell such as shown in FIG. 8B may be “rolled” around a central axis, forming a so-called “jelly roll” configuration, as shown in FIG. 8C according to one embodiment, which may be particularly suitable for certain arrangements or applications, such as for cylindrical or prismatic electrochemical cell embodiments, among others that skilled artisans will comprehend upon reviewing the present disclosure.

While the foregoing electrode, electrolyte, and separator components are the most common and critical aspects of the exemplary electrochemical cell as described herein, it shall be appreciated that according to various implementations electrochemical cells may, or may not, include any suitable combination or permutation of additional or alternative components, such as membranes, cans, caps, casings, wrappings, springs, wires, spacers, tabs, contacts, leads, gaskets, compressive structures or mechanisms, etc. as would be understood by a person having ordinary skill in the art upon reading the present descriptions.

Moreover, it shall be appreciated that persons having ordinary skill in the art may employ the various electrochemical cell embodiments described herein, including but not limited to coin cell arrangements, cylindrical cell arrangements, pouch cell arrangements, prismatic cell arrangements, etc. or any suitable equivalent(s) thereof that would be understood by said skilled artisan upon reading the present disclosure, in any effective permutation or combination, without departing from the scope of the inventive concepts in this disclosure. For instance, multiple of the same arrangements, combinations of different arrangements, or both, may be employed, e.g., to form a battery, or an assembly (e.g., a battery module, or a battery pack, etc. as would be understood by persons having ordinary skill in the art upon reading the present disclosure).

For example, those having ordinary skill in the art will appreciate that different arrangements described herein may have different advantages or disadvantages in the context of different applications, and may choose to employ the most advantageous arrangements of the particular application of interest. Additionally or alternatively, a skilled artisan may include different arrangements to provide robustness across different applications or working conditions to the resulting structure, providing flexibility of use, redundant failure points, or other advantage that would be understood by those having ordinary skill in the art in light of the particular application in mind.

As a concrete example, cylindrical cells are, relative to other arrangements described herein, are prone to cracking. Accordingly, a cylindrical cell arrangement such as shown in FIGS. 10A and 10B may not be applicable to or compatible with a prismatic cell configuration such as shown in FIG. 11, depending on the intended application for a given electrochemical cell, such as applications involving substantial and/or frequent application of mechanical forces (e.g. rapid acceleration/deceleration, vibration, etc. such as often experienced in vehicular applications. Similarly, pouch cell arrangements are particularly sensitive to volumetric expansion and contraction that occurs during natural operation and cycling of the electrochemical cell, and may require or benefit from additional support such as a compressive structure or internal mechanism (e.g. a polymeric support network such as described in U.S. patent application Ser. No. 18/216,340, filed Jun. 29, 2023 and entitled “Internally enclosed support system for batteries, fabrication techniques and applications for the same”, the contents of which are herein incorporated by reference).

Moreover, while exemplary electrochemical cell arrangements expressly described herein and shown in the various Figures include a pouch cell arrangement, a coin cell arrangement, a cylindrical cell arrangement, and a prismatic cell arrangement, other arrangements and/or components may be utilized without departing from the scope of the inventive concepts presented in this disclosure. For example, electrochemical cell arrangements may additionally or alternatively include components or be characterized by arrangements such as chassis, trays, packs, modules, assemblies, casings, etc. as would be understood by those having ordinary skill in the art upon reading the present disclosure.

Of course, the electrochemical cells described herein, according to various embodiments, may include external component(s) at least partially surrounding the electrochemical cell. For instance, exemplary external components may be selected from the group consisting of an external casing enclosing the electrochemical cell, a module operatively coupled to the electrochemical cell, an assembly operatively coupled to the electrochemical cell, a pack enclosing the electrochemical cell, a pouch enclosing the electrochemical cell, a can enclosing the electrochemical cell, a tray operatively coupled to the electrochemical cell, a pan operatively coupled to the electrochemical cell, and combinations thereof. The assembly may comprise: a parallel assembly, an in-series assembly, or a cell-to-chassis assembly.

The presently described inventive concepts include fabricating electrochemical cells of various types using additive manufacturing techniques, injection molding techniques, compression molding techniques, hybrid injection/compression molding techniques, preforming techniques, hand layup techniques, casting techniques, infusion techniques, sintering techniques, or any combination thereof that would be appreciated by a skilled artisan upon reading the present disclosure.

### Inventive Concepts

As noted hereinabove, the various aspects of the inventive concepts presently disclosed are to be understood as capable of being used together, in any combination or permutation that a skilled artisan would appreciate upon reading said disclosure as suitable for making and/or using a functional electrochemical cell, unless expressly stated otherwise. Accordingly, these inventive concepts may be conceptualized as “modular” and capable of being employed in various arrangements, configurations, etc. according to the particular application(s) in which the electrochemical cell is to be utilized. To be clear, the inventive concepts described hereinabove and shown in the various figures shall be understood as including the following implementations, which may include additional or alternative features other than those set forth below, or may omit certain features set forth below, without departing from the scope of the presently described invention.

According to one implementation, an anode includes a three-dimensional (3D) monolith comprising at least one anode active material; and a continuous ion-conducting network formed on surface(s) and/or in a bulk of the 3D monolith, where the ion-conducting network comprises one or more ion-conducting materials. Preferably, the one or more ion-conducting materials collectively comprise about 1-99 wt % of a total mass of the anode, and are homogenously distributed throughout the bulk of the anode. For instance, the ion-conducting network may comprise a plurality of particles of one or more ion-conducting materials distributed throughout the 3D monolith. According to such implementations, the particles may each independently be characterized by a diameter in a range from about 10 nm to about 10 μm, while the anode is characterized by an overall thickness in a range from about 20 μm to about 500 μm. Furthermore, the one or more ion-conducting materials may be, and preferably are, selected from the group consisting of: Li₇La₃Zr₂O₁₂ (LLZO), LiAlO₂, Beta-Al₂O₃(Li⁺), Li₆P₂S₅Cl, Li₆P₂S₅Br, Li₆P₂S₅I, Li₄Ti₅O₁₂ (LTO), LiVO₂ (LVO), LiFePO₄, LiCoO₂, LiNiO₂, LiNi_{0.5}Mn_{0.1}Co_{0.1}O₂ (NMC811), LiNi_{0.33}Mn_{0.33}Co_{0.33}O₂ (NMC111), LiNi_{0.6}Mn_{0.2}Co_{0.2}O₂ (NMC622), SiO₂, SnO₂, NiO, one or more sodium super ionic conductor (NASICON) compounds, NaN(SO₂F)₂, Na₃PS₄, Na₃SbS₄ ceramic, Na₂S—SiS₂ glass, and combinations thereof, where the one or more NASICON compounds are characterized by a chemical composition Na₁₊ₓZr₂SiₓP₃₋ₓO₁₂, (and 0<x<3). In some aspects, the three-dimensional (3D) monolith is a free-standing structure, while according to other aspects the anode may include a current collector electrically coupled to the 3D monolith. Where included in the anode, the current collector preferably comprises a porous, 3D support structure, and the 3D monolith is formed on surfaces of the porous, 3D support structure. Moreover, and again where included, the optional porous, 3D support structure preferably comprises one or more electrically conductive materials selected from the group consisting of: graphite, graphene, graphene oxide, 3D graphene, and combinations thereof. The at least one anode active material of the anode may be selected from elemental lithium, elemental sodium, one or more lithium alloys, one or more sodium alloys, one or more lithium composite materials, one or more sodium composite materials, or combinations thereof. According to various applications, the one or more lithium alloys or the one or more lithium composite materials may be selected from the group consisting of: Li—Mg, Li—Si, Li—Li₃N, Li—LiO₂, Li—LiFePO₄, Li—LiMgPO₄, Li-NMC, Li-NCA, Li—LiCoO₂, and combinations thereof, while the one or more sodium alloys or the one or more sodium composite materials may be selected from the group consisting of Na—Sn, Na—Si, Na—C, and combinations thereof. The at least one anode active material comprises about 1-99 wt % of a total mass of the anode. In use, the anode may be loaded with sulfur in a nonzero amount of up to about 7.5 mg/cm².

According to another implementation, an anode includes a core comprising at least one anode active material; and a shell comprising a continuous ion-conducting network surrounding the core. The node may be characterized by a substantially spherical shape, and may have a diameter in a range from about 1 μm to about 200 μm. In some approaches, the core consists essentially of the at least one anode active material, which may be selected from elemental lithium, elemental sodium, one or more lithium alloys, one or more sodium alloys, one or more lithium composite materials, one or more sodium composite materials, or combinations thereof. According to various applications, the one or more lithium alloys or the one or more lithium composite materials may be selected from the group consisting of: Li—Mg, Li—Si, Li—Li₃N, Li—LiO₂, Li—LiFePO₄, Li—LiMgPO₄, Li-NMC, Li-NCA, Li—LiCoO₂, and combinations thereof, while the one or more sodium alloys or the one or more sodium composite materials may be selected from the group consisting of Na—Sn, Na—Si, Na—C, and combinations thereof. Preferably, the core is in the form of a three-dimensional (3D) monolithic structure. More preferably, the 3D monolithic structure is a free-standing structure. The core may be characterized by a substantially spherical shape having a diameter in a range from about 100 nm to about 200 μm, and/or a surface area to volume ratio in a range from about 6×10⁶ cm to about 149 cm. Optionally, the core may also include a porous, 3D support structure, wherein the at least one anode active material is formed on surfaces of the porous, 3D support structure. Further, the porous, 3D support structure preferably comprises up to about 5 wt % of a total mass of the anode, and/or includes one or more electrically conductive materials selected from the group consisting of: graphite, graphene, graphene oxide, 3D graphene, and combinations thereof. In total, the core may attribute for from about 45 wt % to about 70 wt % of a total mass of the anode. The shell may account for anywhere from about 30 wt % to about 50 wt % of a total mass of the anode, and may be characterized by a substantially spherical shape having a diameter in a range from about 1 μm to about 200 μm and/or a thickness in a range from about 10 nm to about 10 μm. The shell may comprise a plurality of particles independently characterized by a diameter in a range from about 10 nm to about 10 μm. The particles may be present in the form of a plurality of agglomerates dispersed throughout portions of the shell, portions of the core, or both portions of the shell and portions of the core. In some aspects, portions of the continuous ion-conducting network extend into a bulk of the core. Notably, the portions of the continuous ion-conducting network extending into the bulk of the core preferably form one or more continuous, ion-conducting pathways between the bulk of the core and an environment exterior to the shell. The continuous ion-conducting network preferably comprises one or more ion-conducting materials selected from the group consisting of: Li₇La₃Zr₂O₁₂ (LLZO), LiAlO₂, Beta-Al₂O₃ (Li⁺), Li₆P₂S₅Cl, Li₆P₂S₅Br, Li₆P₂S₅I, Li₄Ti₅O₁₂ (LTO), LiFePO₄, LiCoO₂, LiNiO₂, LiNi_{0.8}Mn_{0.1}Co_{0.1}O₂ (NMC811), LiNi_{0.33}Mn_{0.33}Co_{0.33}O₂ (NMC111), LiNi_{0.6}Mn_{0.2}Co_{0.2}O₂ (NMC622), LiVO₂ (LVO), SiO₂, SnO₂, NiO, one or more sodium super ionic conductors (NASICONs), NaN(SO₂F)₂, Na₃PS₄, Na₃SbS₄ ceramic, Na₂S—SiS₂ glass, and combinations thereof.

According to yet another implementation, an anode includes: a core; and a shell surrounding the core. The core comprises either: one or more lithium alloys, one or more lithium composite materials, one or more sodium alloys, one or more sodium composite materials, or combinations thereof; and the shell comprises a plurality of particles including one or more ion-conducting materials selected from the group consisting of: Li₄Ti₅O₁₂ (LTO), LiVO₂ (LVO), Li—LiFePO₄, Li—LiMgPO₄, or combinations thereof. The shell forms a continuous, ion-conducting network between the core and an environment external to the anode. In addition to the foregoing features, the one or more lithium alloys and the one or more lithium composite materials are preferably independently selected from the group consisting of: Li—Mg, Li—Si, Li—Li₃N, Li—LiO₂, Li—LiFePO₄, Li—LiMgPO₄, Li-NMC, Li-NCA, Li—LiCoO₂, or combinations thereof. Similarly, the one or more sodium alloys and the one or more lithium composite materials are preferably independently selected from the group consisting of: Na—Sn, Na—Si, Na—C, or combinations thereof. With continuing reference to the core/shell arrangement of the particularly preferred implementation, the shell and the core may be arranged as distinct physical regions of the anode that do not overlap volumetrically. The shell is may be formed as a layer disposed on an external surface of the core, and the core may be entirely enclosed within an interior volume of the shell. In one particular example, the plurality of particles form a cage surrounding the core. Further still, t the core is a preferably in the form of a free-standing, three-dimensional (3D) monolithic structure.

The foregoing illustrative implementations, among others described herein, may exhibit characteristic performance metrics, such as the anode exhibiting a specific capacity of at least about 450 mAh/g; the anode exhibiting a capacity decay of about 0.1% or less per cycle; the anode exhibiting a cycling capacity of at least about 600 mAh/g at a fifth charge cycle; and/or the anode exhibiting a capacity utilization of at least about 75% relative to a discharge capacity at C/3. In select approaches, the electrochemical cell neither includes nor is coupled to any distinct structure serving as a current collector other than the three-dimensional (3D) monolith.

Moreover, the foregoing illustrative implementations may be included in or utilized with various arrangements of electrochemical cell(s), such as shown in FIGS. 8-11 and described correspondingly hereinabove. For example, in general an electrochemical cell includes an anode as described herein. The electrochemical cell may be configured as a pouch arrangement, a coin arrangement, a cylindrical cell arrangement, a prismatic arrangement, or any other arrangement described herein. Moreover still, the electrochemical cell may be connected to, or operatively coupled to, one or more external components and/or devices in order to deliver electrical power thereto.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The various embodiments of the inventive concepts described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. An anode, comprising:
a core comprising:
at least one anode active material selected from the group consisting of elemental Li, Li—Mg, Li—Si, Li—C, Li—Li₃N, Li—Li₂O, Li—LiFePO₄, Li-NMC, Li-NCA, Li—LiCoO₂, elemental Na, Na—Sn, Na—Si, Na—C; and
one or more lithium ion-conducting materials selected from the group consisting of: Li₇La₃Zr₂O₁₂ (LLZO), LiAlO₂, Beta-Al₂O₃ (Li⁺), Li₆P₂S₅Cl, Li₆P₂S₅Br, Li₆P₂S₅I, Li₄Ti₅O₁₂ (LTO), LiFePO₄, LiCoO₂, LiNiO₂, LiNi_{0.8}Mn_{0.1}Co_{0.1}O₂ (NMC811), LiNi_{0.33}Mn_{0.33}Co_{0.33}O₂ (NMC111), LiNi_{0.6}Mn_{0.2}Co_{0.2}O₂ (NMC622), LiVO₂ (LVO), SiO₂, SnO₂, NiO, Li-LiFePO₄·Li-LiMgPO₄, and combinations thereof;
wherein the one or more lithium ion-conducting materials are homogenously distributed throughout the core; and
a shell surrounding the core and comprising a continuous ion-conducting network;
wherein the continuous ion-conducting network comprises one or more of the lithium ion-conducting materials.

2. The anode as recited in claim 1. wherein the core is a microporous three-dimensional (3D) monolithic structure.

3. The anode as recited in claim 1, wherein the core is a substantially non-porous 3D monolithic structure characterized by less than about 1% of an inner volume of the 3D monolithic structure being attributable to void volume.

4. The anode as recited in claim 1, wherein the core is a non-porous 3D monolithic structure.

5. The anode as recited in claim 1, wherein the anode is characterized by a diameter in a range from about 1 μm to about 200 μm.

6. The anode as recited in claim 1, wherein the core is characterized by a substantially spherical shape.

7. The anode as recited in claim 6, wherein the core is characterized by a diameter in a range from about 100 nm to about 200 μm.

8. The anode as recited in claim 1, wherein the shell is characterized by a thickness in a range from about 10 nm to about 10 μm.

9. The anode as recited in claim 1, wherein portions of the continuous ion-conducting network extend into a bulk of the core.

10. The anode as recited in claim 9, wherein the portions of the continuous ion-conducting network extending into the bulk of the core form one or more continuous, ion-conducting pathways between the bulk of the core and an environment exterior to the shell.

11. The anode as recited in claim 1, wherein the continuous ion-conducting network comprises a plurality of particles homogenously dispersed throughout portions of the shell and portions of the core.

12. The anode as recited in claim 11, wherein the particles are independently characterized by a diameter in a range from about 600 nm to about 10 μm.

13. The anode as recited in claim 11, wherein the particles are present in the form of a plurality of agglomerates.

14. The anode as recited in claim 1, wherein the core is characterized by a surface area to volume ratio in a range from about 6×10⁶ cm⁻¹ to about 149 cm⁻¹.

15. The anode as recited in claim 1, wherein the core further comprises a current collector comprising a porous, 3D support structure; and
wherein the at least one anode active material is formed on surfaces of the porous, 3D support structure.

16. The anode as recited in claim 15, wherein the porous, 3D support structure comprises 3D graphene.

17. The anode as recited in claim 15, wherein the porous, 3D support structure comprises up to about 5 wt % of a total mass of the anode.

18. The anode as recited in claim 1, wherein the core comprises from about 45 wt % to about 70 wt % of a total mass of the anode.

19. The anode as recited in claim 1, wherein the anode is loaded with sulfur in an amount of about 7.5 mg/cm².

20. The anode as recited in claim 1, wherein the core consists essentially of the at least one anode active material.

21. (canceled)

22. (canceled)

23. The anode as recited in claim 1, wherein the shell comprises from about 30 wt % to about 50 wt % of a total mass of the anode.

24. An anode, comprising:
a core comprising at least one anode active material; and
a shell surrounding the core and comprising a continuous ion-conducting network;
wherein the continuous ion-conducting network comprises one or more ion-conducting materials selected from the group consisting of: SiO₂, SnO₂, NiO, one or more sodium super ionic conductors (NASICONs), NaN(SO₂F)₂, Na₃PS₄, Na₃SbS₄ ceramic, Na₂S—SiS₂ glass, and combinations thereof.

25. An electrochemical cell comprising the anode as recited in claim 1.

26. The electrochemical cell as recited in claim 25, wherein the electrochemical cell is characterized by a coin configuration.

27. The electrochemical cell as recited in claim 25, wherein the electrochemical cell is characterized by a cylindrical configuration.

28. The electrochemical cell as recited in claim 25, wherein the electrochemical cell is characterized by a prismatic configuration.

29. The electrochemical cell as recited in claim 25, wherein the electrochemical cell is characterized by a pouch configuration.

30. The electrochemical cell as recited in claim 25, wherein the electrochemical cell neither includes nor is coupled to any distinct structure serving as a current collector other than the core.

31. An electrochemical cell comprising the anode as recited in claim 24.
